(19) United States
(12) Patent Application Publication
(10) Pub. No.: US 2006/0111266 A1
(43) Pub. Date: May 25, 2006

(54) Liquid detergent composition

(75) Inventors: Nazareth Abera, Vlaardingen (NL); Olaf Cornelis P. Beers, Vlaardingen (NL); Irene van Paassen, Vlaardingen (NL); Manoe van Schadewijk, Vlaardingen (NL); Simon Marinus Veerman, Vlaardingen (NL); Angelique Jacqueline B.C. Wagenaar, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/269,909

(22) Filed: Nov. 8, 2005

(30) Foreign Application Priority Data
Nov. 8, 2004 (EP) 04078052.0

(51) Int. Cl. C11D 3/00

(52) U.S. Cl. 510/504

(57) ABSTRACT

The present invention provides an aqueous liquid detergent composition comprising an antifoam system containing saturated fatty acid having an iodine value of lower than 2.0 and further surfactant material, comprising anionic and non-ionic surfactant, but being substantially free of linear alkylbenzene sulfonate (LAS) material. In this connection said detergent composition shows good cleaning performance while having moderate foaming characteristics when in use.

### FIELD OF THE INVENTION

The present invention relates to a liquid detergent composition and a method for treating a textile, especially laundry fabrics, using the same. More in particular, the invention relates to a liquid detergent composition having favourable cleaning and foaming characteristics and having adequate chemical stability.

### BACKGROUND OF THE INVENTION

It is common for modern laundry detergent compositions to contain an antifoam material, particularly when intended for use in front loading automatic washing machines. Excessive foam can inhibit the cleaning process as well as lead to escape of foam from the machine.

The most common kind of antifoam material used is a silicone oil. Being hydrophobic and water immiscible, such silicones are conventionally provided by the manufacturer in the form of a silicone/silica emulsion. However, this may lead to a problem with regard to the stability of the resulting mixture when trying to incorporate such emulsified antifoams into an aqueous liquid detergent formulation.

In this connection, it is an object of the present invention to provide a liquid detergent composition containing a stable antifoam system, and showing good cleaning performance while having moderate foaming characteristics when in use.

It is another object of the invention to provide a liquid detergent composition comprising perfume and enzyme components, that is chemically and physically stable when in storage.

It is an additional object of the invention to provide a detergent with excellent blood stain and fatty stain removal

We have now surprisingly found that one or more of these objects can be achieved when using an aqueous liquid detergent composition according to the present invention.

### DEFINITION OF THE INVENTION

Accordingly, in one aspect the present invention provides an aqueous liquid detergent composition comprising:
(a) an antifoam system containing saturated fatty acid having an iodine value of lower than 2.0;
(b) further surfactant material, comprising anionic and non-ionic surfactant, but being substantially free of linear alkylbenzene sulfonate (LAS).

In the context of the invention, the antifoam system containing saturated fatty acid is intended to mean an antifoam system comprising fatty acid or fatty acid soap or a combination thereof.

As mentioned, the composition is substantially free of linear alkylbenzene sulfonate (LAS). This means that the concentration of said material in the detergent composition of the invention is at most 0.5% by weight, preferably at most 0.2% by weight, more preferably nil. Said composition is hereafter also referred to as “non-LAS”.

Furthermore, in a second aspect the invention provides a method of cleaning textile, comprising the steps of:
(a) diluting from 0.5 to 20 g of a liquid detergent composition according to the present invention with 1 litre of water;
(b) treating the textile with the diluted composition;
(c) rinsing the textile with water; and
(d) drying the textile.

The iodine value according to the present invention is a measure for the level of saturation of the fatty acid: the lower the iodine value of the fatty acid, the higher is the degree of saturation. In connection with the present invention, the iodine value of a fatty acid is defined as the weight of halogens expressed as iodine absorbed by 100 parts by weight of the fatty acid. It follows that a lower iodine value will be measured if the level of saturation of the fatty acid is higher.

The iodine value is determined by the Wijs' method described by IFFO (ISO 3961:1996, May 1998) in which the test sample is dissolved in a solvent and Wijs' reagent added. After about one hour reaction time, potassium iodide and water are added to the mixture. Iodine liberated by the process is titrated with sodium thiosulphate solution.

### DETAILED DESCRIPTION

Linear alkyl benzene sulfonate (LAS) is a widely used type of anionic surfactant. However, it has now been surprisingly found that a non-LAS composition of the present invention, i.e. a detergent composition being substantially free of this surfactant material, has a number of advantages. One advantage is the excellent blood stain removal in combination with good removal of fatty and fatty particulate stains, e.g. removal of lipstick or make-up. Another advantage of non-LAS formulations is that exclusion of the yellowish LAS material results in better colour of the liquid composition. Furthermore, the composition of the invention has a favourable base odour because of reduced formation of rancid smell due to the oxidation of unsaturated soap components; said composition only needs to comprise a low level of saturated fatty acid antifoam for adequate antifoaming characteristics. A further advantage is that non-LAS formulations of the present invention can be equipped with a relatively low-cost enzyme stabilisation system, as the enzymes do not need to be protected from LAS. Further advantages of the composition of the present invention are the skin mildness of the composition and reduced dye fading of fabric articles.

In order to obtain the objects of the invention, in particular the objects with regard to blood stain removal and favourable odour and colour properties, the detergent composition of the invention preferably comprises from 0.1 to 8% by weight of the fatty acid antifoam system, from 0.1 to 50% by weight of the further surfactant material other than fatty acid, and from 0.001 to 3% by weight of enzyme material.

Preferably the aqueous liquid detergent composition has a pH-value between 6 and 12, more preferably between 7 and 10, even more preferably between 7.5 and 9.5. When the pH-value of the detergent composition of the invention is below 7.5, the presence of a pH jump system, i.e. a system that increase the pH-value to above 7.5 on dilution with water, is beneficial for the cleaning performance of said composition.

Preferably, the water content of the liquid detergent composition of the invention is in the range of from 40 to 90% by weight, more preferably form 45 to 85% by weight, still more preferably 60-85% by weight.

The Anti-Foam System

The iodine value according to the present invention is a measure for the level of saturation of the fatty acid; the lower the iodine value of the fatty acid, the higher is the degree of saturation.

Preferably, the fatty acid of the present invention has an iodine value below 1.0, more preferably below 0.3.

Preferably, the fatty acid has a degree of saturation of more than 95%, said degree of saturation being most preferably 100%. Reason is that such saturated fatty acids have been found to perform favourably for reducing and controlling foaming characteristics.

Favourable anti-foaming results were obtained with fatty acid mixtures comprising lauric acid, myristic acid, palmitic acid, stearic acid, arachidic acid and behenic acid. A preferred fatty acid of this type is Prifac 5908 (trade-mark ex Uniqema).

Preferably, the composition comprises the fatty acid of the invention is in a concentration of at least 0.1%, preferably at least 0.2%, more preferably at least 0.4%. The concentration of the fatty acid of the invention in the composition is not more than 8%, preferably less than 4%, more preferably less than 3%.

When preparing the composition of the invention, the composition may be neutralised for obtaining a pH-value above 7.5. For cost reasons, the neutralising agent (if present) is preferably an alkali metal hydroxide, more preferably the neutralising agent is caustic soda (NaOH).

Surfactant Material

The aqueous liquid detergent composition also comprises non-LAS surfactant material other than fatty acid, preferably at a concentration of 0.1 to 50% by weight of the total composition.

This surfactant material in turn comprises one or more nonionic surfactants, preferably at a concentration of 5 to 95% by weight. Additionally, this surfactant material one or more anionic surfactants, preferably at a concentration of 5 to 95% by weight. The surfactant system may also contain cationic, amphoteric or zwitterionic detergent compounds.

In general, the surfactants of the surfactant system may be chosen from the surfactants described in “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Nonionic detergent surfactants are well-known in the art. They normally consist of a water-solubilizing polyalkoxylene or a mono- or di-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof), preferably having from 8 to 20 carbon atoms, monocarboxylic acids having, from 10 to about 24 carbon atoms in the alkyl group and polyoxypropylene. Also common are fatty acid mono- and dialkanolamides in which the alkyl group of the fatty acid radical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in European specification EP-A-225,654. Also preferred are those ethoxylated nonionics which are the condensation products of fatty alcohols with from 9 to 18 carbon atoms condensed with from 3 to 11 moles of ethylene oxide. Examples of these are the condensation products of C₉₋₁₈ alcohols with on average 3 to 9 moles of ethylene oxide. Preferred for use in the liquid detergent composition of the invention are C₁₂-C₁₅ primary, linear alcohols with on average 3 to 9 ethylene oxide groups.

Preferably the non-ionic surfactant of the present inventions is a C₁₂₋₁₈ ethoxylated alcohol, comprising 3 to 9 ethylene oxide units per molecule. More preferred are C₁₂-C₁₅ primary, linear ethoxylated alcohols with on average 5 to 9 ethylene oxide groups, more preferably on average 7 ethylene oxide groups.

Suitable anionic surfactants for the detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals, including alkyl sulphates, alkyl ether sulphates, alkaryl sulphonates, alkanoyl isethionates, alkyl succinates, alkyl sulphosuccinates, N-alkoyl sarcosinates, alkyl phosphates, alkyl ether phosphates, alkyl ether carboxylates, alpha-olefin sulphonates and acyl methyl taurates, especially their sodium, magnesium ammonium and mono-, di- and triethanolamine salts. The alkyl and acyl groups generally contain from 8 to 22 carbon atoms, preferably 8 to 18 carbon atoms, still more preferably 12 to 15 carbon atoms and may be unsaturated. The alkyl ether sulphates, alkyl ether phosphates and alkyl ether carboxylates may contain from one to 10 ethylene oxide or propylene oxide units per molecule, and preferably contain 1 to 3 ethylene oxide units per molecule.

Examples of suitable anionics include sodium lauryl sulphate, sodium lauryl ether sulphate, ammonium lauryl sulphosuccinate, ammonium lauryl sulphate, ammonium lauryl ether sulphate, sodium cocoyl isethionate, sodium lauroyl isethionate, and sodium N-lauryl sarcosinate.

Preferably the anionic surfactant of the present invention is sodium alcohol ethoxy-ether sulphate (SAES), preferably comprising high levels of sodium C₁₂ alcohol ethoxy-ether sulphate.

Preferred surfactant systems are mixtures of anionic with nonionic detergent active materials and additionally cationic or amphoteric surfactant. Especially preferred is a surfactant system that is a mixture of alcohol ethoxy-ether sulphate (AES) and a C₁₂-C₁₅ primary ethoxylated alcohol 3-9 EO ethoxylate and a quaternary ammonium cationic surfactant as further described hereinafter.

Anionic surfactants can be present for example in amounts in the range from about 5% to about 70% by weight of the total surfactant material.

The presence of the saturated fatty acid antifoam system, enables the use of low levels of higher foaming cationic as well as amphoteric and/or zwitterionic surfactants, while keeping the foaming at an acceptable level. In a preferred embodiment of the invention, the detergent compositions also comprises a cationic surfactant or an amphoteric surfactant, wherein the cationic or amphoteric surfactant is present in a concentration of 1 to 20%, preferably 2 to 15% more preferably 3 to 12% by weight of the total surfactant.

Suitable cationic surfactants compounds which may be used are substituted or unsubstituted straight-chain or branched quaternary ammonium salts. Preferably the cationic surfactant is of the formula:
R¹R²R³R⁴N⁺X⁻
wherein R¹ is C₈-C₂₂-alkyl, C₈-C₂₂-alkenyl, C₈-C₂₂-alkylalkenylamidopropyl or C₈-C₂₂-alkoxyalkenylethyl, R² is C₁-C₂₂-alkyl, C₂-C₂₂-alkenyl or a group of the formula -A-(OA)ₙ—OH, R³ and R⁴ are C—C₂₋₂-alkyl, C₂-C₂₁-alkenyl or a group of the formula -A-(OA)ₙ—OH, A is —C₂H₄— and/or —C₃H₆— and n is a number from 0 to 20 and X is an anion. A commercially available and preferred example of this type of cationic surfactant is a compound of the formula above, where R¹ is a C_{12/14} alkyl group, R² is a group of the formula -A-(OA)ₙ—OH, wherein A is —C₂H₄— and n is nil, and R³ and R⁴ are both —CH₃ (i.e. C₁-alkyl). This type of cationic surfactant is commercially available from e.g. Clariant under the name Praepagen HY.

Typical examples of suitable amphoteric and zwitterionic surfactants are alkyl betaines, alkylamido betaines, amine oxides, aminopropionates, aminoglycinates, amphoteric imidazolinium compounds, alkyldimethylbetaines or alkyldipolyethoxybetaines.

Enzymes

Suitable enzymes that may be used in the composition of the present invention include proteases, amylases, lipases, cellulases, peroxidases, and mixtures thereof, of any suitable origin, such as vegetable, animal bacterial, fungal and yeast origin. Preferred selections are influenced by factors such as pH-activity, thermostability, and stability to active bleach detergents, builders and the like. In this respect bacterial and fungal enzymes are preferred such as bacterial proteases and fungal cellulases.

Enzymes are normally incorporated into detergent composition at levels sufficient to provide a “cleaning-effective amount”. The term “cleaning effective amount” refers to any amount capable of producing a cleaning, stain removal, soil removal, whitening, or freshness improving effect on the treated substrate. In practical terms for normal commercial operations, typical amounts are up to about 50 mg by weight, more typically 0.01 mg to 30 mg, of active enzyme per gram of detergent composition. Stated otherwise, the composition of the invention may typically comprise from 0.001 to 3%, preferably from 0.01 to 1% by weight of a commercial enzyme preparation.

Protease enzymes are usually present in such commercial preparations at levels sufficient to provide from 0.005 to 0.1 Anson units (AU) of activity per gram of composition. Higher active levels may be desirable in highly concentrated detergent formulations.

Suitable examples of proteases are the subtilisins that are obtained from particular strains of B. subtilis and B. licheniformis. One suitable protease is obtained from a strain of Bacillis, having maximum activity throughout the pH-range of 8-12, developed and sold as ESPERASE® by NovoZymes of Denmark.

Other suitable proteases include ALCALASE® and SAVINASE® RELASE® from NovoZymes and MAXATASE® from International Bio-Synthetics, Inc., The Netherlands.

The composition may additionally comprise enzymes as found in WO 01/00768 A1 page 15, line 25 to page 19, line 29, the contents of which are herein incorporated by reference.

Suitable lipase enzymes for use in the composition of the invention include those produced by microorganisms of the Pseudomonas group, such as Pseudomonas stutzeri ATCC 19.154, as disclosed in GB-1,372,034. A very suitable lipase enzyme is the lipase derived from Humicola lanuginosa and available from NovoZymes under the tradename LIPEX®.

Perfumes

The liquid composition of the present invention preferably comprises between 0.001 to 3% by weight of a perfume composition, more preferably between 0.1 to 2% by weight of a perfume composition. Said perfume composition preferably comprises at least 0.01% by weight based on the liquid composition of a perfume component selected from terpenes, ketones, aldehydes and mixtures thereof. The perfume composition may fully consist of the perfume component but generally the perfume composition is a complex mixture of perfumes of various differing perfume classifications. In this regard, the perfume composition preferably comprises 0.1 to 2% by weight of the perfume component.

Having regard to the terpene perfume component, the present invention has particular utility with the following preferred terpene perfume components: Terpinolene, Gamma-terpinene and pinane.

Having regard to the ketone perfume component, the present invention has particular utility to the following preferred ketonic perfume components: pulegone, vertofix coeur, veloutone, Alpha-methylionone and damascenone.

With regard to the aldehyde perfume component, the present invention has particular utility with the following preferred aldehyde perfume components: trifernal, lilial, citronellal, cyclosal, heliopropanal, zestover, Aldehyde C12, tridecylenicaldehyde and cyclosia base octenal

Bleaches

The liquid detergent composition of the present invention may also comprise bleaching material.

Particularly preferred bleaching ingredients are those capable of yielding hydrogen peroxide in aqueous solution, the so-called peroxyl species. Hydrogen peroxide sources are well known in the art. They include the alkali metal peroxides, organic peroxides such as urea peroxide and PAP (N,N-phthaloylaminoperoxy caproic acid). Mixtures of two or more such compounds may also be suitable.

Since many bleaches and bleach systems are unstable in aqueous liquid detergents and/or interact unfavourably with other components in the composition, e.g. enzymes, they may for example be protected, e.g. by encapsulation or by formulating a structured liquid composition, whereby they are suspended in solid form.

Alternatively or in addition to, a transition metal catalyst may be used with the peroxyl species, see, for example WO-02/48301. A transition metal catalyst may also be used in the absence of peroxyl species where the bleaching is termed to be via atmospheric oxygen, see, for example WO-00/52124 and WO-02/48301. The transition metal catalysts disclosed in WO-00/52124 and WO-02/48301 are generally both applicable to what is known in the art as “air mode” and “peroxyl mode” bleaching. Another example of a suitable class of transition metal catalysts is found in WO-02/48301 and references found therein.

If a peroxygen bleach is present in the composition the presence of a transition metal chelating agent is preferred to stabilise the peroxygen bleach.

Photobleaches, including singlet oxygen photobleaches, may also be used in the liquid detergent composition of the invention.

When the composition is in the form of a liquid, segregation of various components may be necessary and these will be evident to one skilled in the art. One form of segregation that is preferred is that of coacervation. The use of pH-Jump compositions and antioxidants are also applicable to preserving the integrity of certain components within the composition.

pH-Jump System

For obtaining favourable cleaning performance when the composition of the invention is used for treating textile, it is preferred that the pH-value of said composition is above 7.5 in the diluted washing solution. For the compositions of the present invention with a pH-value below 7.5, it is preferred that said composition additionally contains a pH-changing means capable of bringing about this increase of pH-value. Desirably, the pH-changing means is capable of raising the pH-value to at least 8 upon dilution with water.

The pH-changing means is effectively provided by a pH-jump system containing a boron compound, particularly borax decahydrate, and a polyol. The borate ion and certain cis 1,2-polyols complex when present in the undiluted composition, so as to cause a reduction in pH-value to a value of less than or equal to 7. Upon dilution, the complex dissociates liberating free borate to raise the pH-value in the diluted solution resulting in a pH-jump. Examples of polyols that exhibit the complexing mechanism with borax include catechol, galactitol, fructose, sorbitol, and pinacol. For economic reasons, sorbitol is the preferred polyol.

The desired ratio of the polyol to the boron compound needs to be considered since it influences performance. The level of the boron compound, particularly borax, incorporated in the composition of the invention also influences the performance. Borax levels of at least 1% by weight are desired to ensure sufficient buffering. Excessive amounts of borax (>10% by weight) give good buffering properties; however, such levels lead to a pH-value of the undiluted composition that is higher than desired. Generally, pH-jump systems in which the weight ratio of the polyol and boron compound ranges from 1:1 to 10:1 are preferred for use in the present invention.

When applying a borax-sorbitol pH-jump system, said system preferably comprises at least 2% by weight of Sorbitol and at least 1% by weight of borax. In practice, compositions containing, as a pH-jump system, a combination of 5% wt borax and 20% wt sorbitol were found to yield the best results. Such a pH-jump system is known from EP-A-381,262. Salts of calcium and magnesium have been found to enhance the pH-jump effect by further lowering the pH of the undiluted composition. Other di- and trivalent cations may be used but Ca and Mg are preferred. Any anion may be used providing the resulting Ca/Mg salt is sufficiently soluble. Chloride, although it could be used, is not preferred because of oxidation problems.

Other types of pH-jump systems are based on the principle of insoluble alkaline salts in the undiluted composition that dissolve on dilution to raise the solution pH. Examples of such alkaline salts are sodium tripolyphosphate (STP), sodium carbonate, sodium bicarbonate, sodium silicate, sodium pyro- and ortho-phosphate.

An alternative type of pH-jump system for use in a liquid detergent composition includes a metal cation and an N-containing compound, as disclosed in U.S. Pat. No. 5,484,555.

Other Components

The liquid detergent composition of the invention may additionally comprise builders, solvents, sequestrants, polymers, preservatives, fluorescers, dyes, biocides, buffers, salts (e.g. citrate) and hydroptropes (e.g. sodium cumene sulphonate).

Builders, polymers and further enzymes as optional ingredients may also be present, as found in WO-00/60045. Suitable detergency builders as optional ingredients may also be present, as found in WO-00/34427. One salt of particular interest is citrate, because of its additional builder and bleaching characteristics.

The present invention extends to both isotropic and complex liquid compositions, a brief discussion of which follows. Isotropic liquid compositions are clearly preferred Some isotropic formulations are termed ‘micro-emulsion’ liquids that are clear and thermodynamically stable over a specified temperature range. The ‘micro-emulsion’ formulation may be water in oil, or oil in water emulsions. Some liquid formulations are macro-emulsions that are not clear and isotropic. Emulsions are considered meta-stable. Liquid formulations of the present invention may also contain for example; monoethoxy quats; AQAs and bis-AQAs; cationic amides; cationic esters; amino/diamino quats; glucamide; amine oxides; ethoxylated polyethyleneimines; enhancement polymers of the form linear amine based polymers, e.g. bis-hexamethylenetriamine; polyamines e.g. TETA, TEPA or PEI polymers.

The liquid composition preferably also contains one or more antioxidants as described in WO-02/072747 and WO-02/072746.

The invention will now be illustrated by way of the following non-limiting examples, in which all parts and percentages are by weight unless otherwise indicated.

### EXAMPLES 1 AND 2 AND COMPARATIVE EXAMPLES A AND B

Foam tests were carried out in 2 types of automatic front loader washing machines.

Machine 1 is a Miele Hydromatic W968 automatic washing machine. The program used was the normal white cycle at 30 degrees C., which had a total duration of 115 min. The main wash had a duration of 57 min and a water intake of 13 litres. The main wash was followed by four rinse steps, with water intakes of 10, 12, 13 and 13 litres respectively and a flood step of 1 litre. The total water consumption was 62 litres.

Machine 2 is a Whirlpool AWM 857 automatic washing machine. The program used was the normal white cycle at 30 degrees C., which had a total duration of 114 min. The main wash had a duration of 57 min and a water intake of 16 litres. The main wash was followed by three rinse steps, with water intakes of 25, 17 and 21 litres respectively. The total water consumption was 86 litres.

The water hardness was 40 degrees fH, unless specified otherwise. The load of the washing machine consisted of 4 terry towels. 180 ml of the specified detergents was dosed.

The foam level was visually detected in the porthole, wherein the porthole is the glass window in the door of the washing machines used for the experiments.

The foam level in the porthole was measured with a centimetre scale, registering the height of the foam layer (H_{foam}). The amount of foam (% F) was calculated with formula (1):

$$\% F = \frac{{H}_{foam}}{{H}_{porthole}} ⋆ 100 \% \qquad ( 1 )$$

Wherein Hₚₒᵣₜₕₒₗₑ is the distance between the liquid level in the porthole and the top of the porthole. The amount of foam (% F) was recorded every 10 minutes during the entire washing cycle.

In the present examples, the effect was investigated of the fatty acid antifoam of the invention on the reduction foaming during the washing cycle.

Table 1 gives the two detergent compositions used in examples 1 and 2 (“comp 1”), respectively comparative examples A and B (“comp 2”).

TABLE 1

| | Comp 1 | Comp 2 |
|---|---|---|
| | (% wt) | (% wt) |
| Nonionic - NEODOL 25-7 | 8.5 | 8.5 |
| Anionic - SLES 3EO | 8.5 | 8.5 |
| Fatty acid - Prifac 5908 | 1.0 | |
| Fatty acid - Prifac 7908 | | 1.0 |
| Minors | 11.8 | 11.8 |
| Water | 70.2 | 70.2 |
| Total | 100 | 100 |

Minors include enzymes, salts, buffers, fluorescers, perservatives and perfumes. All percentages are given as concentrations in the composition.

As can be noticed, in the above detergent composition of the invention (“Comp 1”), Prifac 5908 (trademark ex Uniqema) is used which is a saturated fatty acid antifoam. On the other hand, in the composition outside the scope of the invention (“Comp 2”), Prifac 7908 (trademark ex Uniqema) being an unsaturated fatty acid soap is present. The compositions have a pH of 8.5 at 25 degrees C.

In examples 1 and 2, the Miele washing machine, respectively the Whirlpool washing machine were used as described above, whereby the detergent composition ‘Comp 1’ was applied. In comparative examples A and B the Miele washing machine, respectively the Whirlpool washing machine were used as described above, whereby the detergent composition ‘Comp 2’ was applied, comprising an unsaturated fatty acid soap (Prifac 7908).

The results with regard to the foam behaviour of examples 1 and 2 and comparative examples A and B are given in Table 2.

TABLE 2

| | Example | | | |
|---|---|---|---|---|
| | 1 | 2 | A | B |
| Time | Foam level | Foam level | Foam level | Foam level |
| (hh.mm.ss) | (% F) | (% F) | (% F) | (% F) |
| 00:00:00 | 0 | 0 | 0 | 0 |
| 00:10:00 | 8 | 49 | 8 | 11 |
| 00:20:00 | 3 | 17 | 20 | 23 |
| 00:30:00 | 3 | 15 | 22 | 31 |
| 00:40:00 | 2 | 15 | 25 | 38 |
| 00:50:00 | 2 | 14 | 26 | 41 |
| 01:00:00 | 13 | 7 | 19 | 43 |
| 01:10:00 | 17 | 42 | 26 | 43 |
| 01:20:00 | 7 | 49 | 7 | 46 |
| 01:30:00 | 6 | 83 | 0 | 83 |
| 01:40:00 | 1 | 5 | 0 | 6 |
| 01:50:00 | 0 | 0 | 0 | 0 |
| 02:00:00 | 0 | 0 | 0 | 0 |

| | Composition | | | |
|---|---|---|---|---|
| | Comp 1 | Comp 1 | Comp 2 | Comp 2 |
| Machine | Miele | Whirlpool | Miele | Whirlpool |
| | (W968) | (AWM 857) | (W968) | (AWM 857) |
| Temperature (deg | 30 | 30 | 30 | 30 |
| C.) | | | | |
| Hardness (deg fH) | 40 | 40 | 40 | 40 |

The table above clearly shows that the foam level (% F) during the main wash (from 00:20:00 to 1:10:00) is lower when using a composition comprising a saturated fatty acid antifoam according to the present invention, as compared to a composition comprising an unsaturated fatty acid soap.

### EXAMPLES 3 AND 4 AND COMPARATIVE EXAMPLES C AND D

The addition of cationic surfactant generally would lead to more foaming. The reduction of foaming in compositions of the invention containing cationic surfactant are shown in these examples.

The detergent compositions applied are shown in Table 3.

TABLE 3

| | Comp 3 | Comp 4 | Comp 5 | Comp 6 |
|---|---|---|---|---|
| | (%) | (%) | (%) | (%) |
| Nonionic - NEODOL 25-7 | 8.5 | 8.5 | 8.5 | 8.5 |
| Anionic - SLES 3EO | 8.5 | 8.5 | 8.5 | 8.5 |
| Prifac 7908 | | 1.0 | | 1.0 |
| Prifac 5908 | 1.0 | | 1.0 | |
| Cationic - Praepagen HY | 1.0 | 1.0 | 1.0 | 1.0 |
| Minors | 11.8 | 11.8 | 11.8 | 11.8 |
| Water | 69.2 | 69.2 | 69.2 | 69.2 |
| Total | 100 | 100 | 100 | 100 |
| Water hardness (°fH) | 40 | 40 | 5 | 5 |

Minors include enzymes, salts, buffers, fluorescers, perservatives and perfumes. All percentages are given as concentrations in the composition.

In the examples 3 and 4 and comparative examples C and D, the Whirlpool washing machine was used as described above. The detergent applied in example 3 (Comp 3), comprises the saturated fatty acid antifoam system (Prifac 5908) and 1% cationic surfactant. In comparative example C the detergent composition Comp 4 was applied, comprising unsaturated fatty acid soap (Prifac 7908) and 1% cationic surfactant. Compositions 5 and 6 are equal to compositions 3 and 4 respectively and were used in examples 4 and D, but using a water hardness of 5 degrees fH.

The method for the determination of the foam level in examples 3 and 4 and comparative examples C and D is as described in examples 1 and 2 and comparative examples A and B above. The following results were obtained.

TABLE 4

| | Example | | | |
|---|---|---|---|---|
| | 3 | C | 4 | D |
| Time | Foam level | Foam level | Foam level | Foam level |
| (hh.mm.ss) | (% F) | (% F) | (% F) | (% F) |
| 00:00:00 | 0 | 0 | 0 | 0 |
| 00:10:00 | 66 | 50 | 22 | 38 |
| 00:20:00 | 46 | 58 | 25 | 49 |
| 00:30:00 | 38 | 60 | 31 | 53 |
| 00:40:00 | 39 | 59 | 33 | 58 |
| 00:50:00 | 42 | 57 | 34 | 78 |
| 01:00:00 | 32 | 59 | 39 | 86 |
| 01:10:00 | 31 | 58 | 49 | 98 |
| 01:20:00 | 57 | 64 | 53 | 85 |
| 01:30:00 | 95 | 99 | 24 | 70 |
| 01:40:00 | 93 | 81 | 6 | 36 |
| 01:50:00 | 4 | 13 | 0 | 5 |
| 02:00:00 | 0 | 0 | 0 | 5 |

| | Composition | | | |
|---|---|---|---|---|
| | Comp 3 | Comp 4 | Comp 5 | Comp 6 |
| Machine | Whirlpool | Whirlpool | Whirlpool | Whirlpool |
| | (AWM 857) | (AWM 857) | (AWM 857) | (AWM 857) |
| Temperature | 30 | 30 | 30 | 30 |
| (deg C.) | | | | |
| Hardness (deg | 40 | 40 | 5 | 5 |
| fH) | | | | |

The table above clearly shows that the foam level (% F) during the main wash (from 0:20:00 to 1:10:00) is lower when using a saturated fatty acid soap antifoam according to the present invention, as compared to unsaturated fatty acid soap, even when 1% cationic surfactant is added.

### EXAMPLE 5 AND COMPARATIVE EXAMPLE E

Stain removal performance (extent of cleaning) was measured with a dual beam integrating sphere reflectance spectrophotometer (Datacolor SF600V+). In the spectrophotometer, light is directed at the surface of the sample and the reflected light is measured photoelectrically. The reflected light is expressed as a percentage (% R) at a wavelength of 460 nm. The cleaning results are expressed as ‘Delta R’, which is the difference in reflectance of the soil monitors after and before the washing cycle, as measured with the reflectometer at 460 nm. In these examples the difference in ‘Delta R’ (Delta Delta R) between the comparative example and the detergent composition of the invention (Delta Delta R=‘Delta Rᵢₙᵥₑₙₜᵢₒₙ’−‘Delta R_{comparative}’) is determined.

Cotton test swatches were acquired from WFK Testgewebe, Brüggen-Bracht, Germany. The tested swatches are 10LS, and 10MU, stained with lipstick and make-up respectively.

The test cloths were washed together with 3 kilogram clean cotton load in a Miele W918 automatic front loading washing machine. The program used was the normal white cycle (NWC) at 60 degrees C. The water hardness was 40 degrees fH. The compositions used for the example are ‘comp 7’ showing a composition according to the invention, comprising the saturated fatty acid antifoam system (2%) and cationic surfactant (1%) and the comparative detergent composition ‘comp 8’ which does not contain cationic surfactant and wherein the saturated fatty acid antifoam is replaced with a comparable un-saturated fatty acid soap. Both compositions are shown in Table 5.

TABLE 5

| | Comp 7 | Comp 8 |
|---|---|---|
| | (%) | (%) |
| Nonionic - NEODOL 25-7 (100%) | 6.25 | 8.5 |
| Anionic - SLES 3EO (70%) | 6.25 | 8.5 |
| Prifac 7908 (100%) | | 1.0 |
| Prifac 5908 (100%) | 2.0 | |
| Cationic - Praepagen HY (40%) | 1.0 | |
| Minors | 11.8 | 11.8 |
| Water | 72.7 | 70.2 |
| Total | 100 | 100 |

Minors include enzymes, salts, buffers and perfumes. It can be seen in Table 5 that composition ‘comp 7’ of the example has a lower total surfactant content (15.5%) compared to the composition ‘comp 8’ of the comparative detergent composition.

The cleaning results, given as comparative ‘Delta Delta R’ values are given in Table 6.

TABLE 6

| | WFK Cat. No. | Delta Delta R |
|---|---|---|
| Lipstick | 10 LS, 10045 | +6.6 |
| Make-Up fluid | 10 MU, 10047 | +2.8 |

The results in Table 6 show that the detergent composition of the invention has a 6.6 better stain removal on lipstick and 2.8 on Make-Up, even with a lower total surfactant level.

### EXAMPLE 6 AND 7 AND COMPARATIVE EXAMPLE F

Another object of the invention is the stability of sensitive ingredients, e.g. enzymes. The present examples show improved enzyme stability of the detergent compositions of the present invention.

A good indicator for the stability of a solution, is the relative enzyme activity before and after storage for four weeks at a temperature of 37 degrees C.

In Table 7 below, the detergent compositions used in the example are given.

TABLE 7

| | Comp 9 | Comp 10 | Comp 11 |
|---|---|---|---|
| | (%) | (%) | (%) |
| Nonionic - NEODOL | 5.67 | 8.5 | 8.5 |
| 25-7 | | | |
| Anionic - SLES 3EO | 5.67 | 8.5 | 8.5 |
| Anionic - LAS | 5.67 | | |
| Prifac 7908 | 1 | | |
| Prifac 5908 | | 1 | 1 |
| Cationic - Praepagen | | | 1 |
| HY | | | |
| Savinase 16L EX | 0.39 | 0.39 | 0.39 |
| NaCl | 2 | 2 | 2 |
| Minors | 9.8 | 9.8 | 9.8 |
| Water | 70.2 | 70.2 | 69.2 |
| Total | 100 | 100 | 100 |

Composition ‘comp 9’ is a LAS containing composition for the purpose of comparison. Composition ‘comp 10’ is a composition of the invention comprising the saturated fatty acid antifoam, non-LAS anionic surfactant and nonionic surfactant, whereas composition ‘comp 11’ is a composition of the invention comprising the saturated fatty acid antifoam, non-LAS anionic surfactant, nonionic surfactant and cationic surfactant. The total base surfactant (anionic, nonionic and fatty acid) in the compositions of this example (‘comp 9’, ‘comp 10’ and ‘comp 11’) is kept constant at 18% by weight of the total composition.

The residual activity of the Savinase 16L (trade mark, ex NovoZymes) enzyme in all thus-formed formulations after 4 weeks storage at 37° C., was determined at 40° C. in a TRIS pH 9 buffer and using tetrapeptide as substrate. For this determination, the following protocol was used:

Samples of 70 mg of the tested liquid formulation were diluted in 10.00 ml MilliQ water. 10 μl of this solution was added to an assay of 205 μl containing 74.4 mM TRIS pH9 and 0.494 mM tetrapeptide (succinyl-Ala-Ala-Pro-Phe-p-Nitroanilide). The absorbance of the tested samples at a wavelength of 450 nm was measured for 15 minutes at 40° C., using a spectrophotometer. The absolute changes in absorbance as compared to the absorbance measured on a freshly prepared calibration sample were correlated to the measured activity of such freshly prepared sample. The measured protease enzyme activity is expressed as GU/ml.

The residual enzyme activity (expressed as %) is the enzyme activity after storage of the liquid formulation concerned divided by the enzyme activity measured at t=0.

Table 8 shows the effect of LAS and cationic surfactant on the residual enzyme activity in liquid detergent compositions, after 4 weeks storage at 37° C.

TABLE 8

Example

| | | |
|---|---|---|
| F | 6 | 7 |

Composition

| | | |
|---|---|---|
| Comp 9 | Comp 10 | Comp 11 |
| (%) | (%) | (%) |

| | | | |
|---|---|---|---|
| Savinase 16 L EX activity | 8 | 81 | 90 |

This table clearly shows that Savinase stability in a non-LAS detergent composition is better than in a LAS-containing composition. As can be seen, 81% of the enzyme is maintained in the non-LAS composition during storage at 37 degrees C. for four weeks, while only 8% is found in the LAS-containing formulation after the same treatment. The use of an additional cationic surfactant further enhances the stability to up to 90% residual activity after four weeks at 37 degrees C. (see Example 7).

### EXAMPLE 8 AND COMPARATIVE EXAMPLES G AND H

This example demonstrates the benefit of the addition of a minor amount of cationic surfactant to obtain not only excellent bloodstain removal, but also very good results on fatty stain removal, even without the presence of LAS.

Stain removal performance (extent of cleaning) was measured with a dual beam integrating sphere reflectance spectrophotometer (Datacolor SF600V+). In the spectrophotometer, light is directed at the surface of the sample and the reflected light is measured photoelectrically. The reflected light is expressed as a percentage (% R) at a wavelength of 460 nm. The cleaning results are expressed as ‘ΔR’, which is the difference in reflectance of the soil monitors after and before the washing cycle, as measured with the reflectometer at 460 nm.

Cotton test swatches were acquired from CFT BV, Vlaardingen, Then Netherlands. The tested swatches are EMPA-111, and WFK-10LS, stained with blood and lipstick respectively.

In example 8, a composition (comp 11) comprising the fatty acid antifoam of the invention in combination with SLES anionic, Neodol 25-7 nonionic and 1% of Praepagen HY cationic surfactant is used. In comparative example G, a composition (comp 9) comprising LAS an SLES anionic and Neodol 25-7 nonionic is used and in comparative example H a composition (comp 10) comprising SLES anionic and Neodol 25-7 nonionic is used. In all three experiments, the total surfactant contents is 18%.

TABLE 9

| | Comp 9 | Comp 10 | Comp 11 |
|---|---|---|---|
| | (%) | (%) | (%) |
| LAS | 5.66 | | |
| SLES 3EO (70%) | 5.66 | 8.5 | 8 |
| NEODOL 25-7 (100%) | 5.66 | 8.5 | 8 |
| Prifac 5908 (100%) | 1 | 1 | 1 |
| Cationic - Praepagen HY (40%) | | | 1 |
| Total surfactant | 18.0 | 18.0 | 18.0 |
| Minors | 9.8 | 9.8 | 9.8 |
| Water | 72.2 | 72.2 | 72.2 |
| Total | 100 | 100 | 100 |

Minors include enzymes, salts, buffers and perfumes.

The test swatches are washed in a Lauder-O-meter (Linitest). The Launder-O-meter consists of a waterbath, with a rotating rack with metal jars. The jars contain 800 ml of water, 8 g/l of the compositions of the respective examples from Table 9, the test swatches and 20 metal balls for agitation.

The run is started with a 15 minutes heating step, to heat the water in the jars from 25 to 60° C. The heating is followed by a washing step at 60° C. for 30 min. The total run time is therefore 45 min.

The cleaning results, given as comparative ΔR₄₆₀ values are given in Table 10 as well as the corresponding standard deviations of the measurement.

TABLE 10

| | | | Comp | | | |
|---|---|---|---|---|---|---|
| | Comp Example G | | Example H | | Example 8 | |
| | ΔR₄₆₀ | St Dev | ΔR₄₆₀ | St Dev | ΔR₄₆₀ | St Dev |
| EMPA-111 | 42.2 | 1.4 | 47.7 | 1.4 | 45.1 | 0.5 |
| WFK-10LS | 65.3 | 1.7 | 50.3 | 1.0 | 58.4 | 2.0 |

Although the composition of example 8 scores lower on blood stain removal than the composition of comparative example H and lower on fatty stain removal than comparative example G, the composition of example 8 has a high performance on both stain types, rather than excelling in removing only one. The results in Table 10 further show that the composition (comp 10) of comparative example H without LAS has improved blood stain removal (EMPA-111) at the expense of reduced fatty stain removal (WFK-10LS) with the same amount of total surfactant. It is also shown that the addition of 1% of cationic (example 8) significantly improves the fatty stain removal, while maintaining high bloodstain removal.

1. An aqueous liquid detergent composition comprising:
(a) an antifoam system containing saturated fatty acid having an iodine value of lower than 2.0; and
(b) further surfactant material, comprising anionic and non-ionic surfactant, but being substantially free of linear alkylbenzene sulfonate (LAS).

2. A detergent composition according to claim 1, wherein the composition comprises a cationic or amphoteric surfactant in a concentration of 1 to 20% by weight of the total surfactant.

3. A detergent composition according to claim 1, wherein the cationic surfactant is a material of the formula: R¹R²R³R⁴N⁺X⁻, wherein R¹ is C₈-C₂₂-alkyl, C₈-C₂₂-alkenyl, C₈-C₂₂-alkylalkenylamidopropyl or C₈-C₂₂-alkoxyalkenylethyl, R² is C₁-C₂₂-alkyl, C₂-C₂₂-alkenyl or a group of the formula -A-(OA)ₙ—OH, R³ and R⁴ are C₁-C₂₂-alkyl, C₂-C₂₁-alkenyl or a group of the formula -A-(OA)ₙ—OH, A is —C₂H₄— and/or —C₃H₆— and n is a number from 0 to 20 and X is an anion.

4. A detergent composition according to claim 3, wherein R¹ is a C_{12/14} alkyl group, R² is a group of the formula -A-(OA)ₙ—OH, wherein A is —C₂H₄— and n is nil, and R³ and R⁴ are both —CH₃ (i.e. C₁-alkyl).

5. A detergent composition according to claim 1, wherein said composition has a pH-value between 6 and 12, preferably between 7 and 10.

6. A detergent composition according to claim 1, wherein the composition comprises an enzyme material, selected from proteases, amylases, lipases, cellulases, peroxidases, and mixtures thereof, and wherein said enzyme material is present in said composition in a concentration of from 0.001 to 3% by weight.

7. A detergent composition according to claim 1, wherein the iodine value is lower than 1.0.

8. A detergent composition according to claim 1, wherein the fatty acid is a mixture of lauric acid, myristic acid, palmitic acid, stearic acid, arachidic acid and behenic acid.

9. A detergent composition according to claim 1, wherein the composition comprises from 0.1 to 8% by weight of the antofoam system.

10. A detergent composition according to claim 1, wherein the anionic surfactant is sodium alcohol ethoxy-ether sulphate (SAES).

11. A detergent composition according to claim 1, wherein the nonionic surfactant is an ethoxylated alcohol, and comprises more than 10% by weight of the total surfactant.

12. A detergent composition according to claim 1, wherein said composition also comprises a perfume composition.

13. A detergent composition according to claim 1, wherein the water content of said composition is in the range of from 40 to 90% by weight.

14. A detergent composition according to claim 1, wherein the composition comprises:
(a) 0.1-8% by weight of the saturated fatty acid soap;
(b) 0.1-50% by weight of the further surfactant material other than fatty acid soap; and
(c) 0.001-3% by weight of the enzyme material.

15. A method of cleaning textile, comprising the steps of:
(a) diluting from 0.5 to 20 g of a liquid detergent composition according claim 1 with 1 litre of water;
(b) treating the textile with the diluted composition;
(c) rinsing the textile with water; and
(d) drying the textile.
